(19) United States
(12) Patent Application Publication
(10) Pub. No.: US 2007/0293280 A1
(43) Pub. Date: Dec. 20, 2007

(54) CURVED ROTATOR SYLE FORM FACTOR FOR ELECTRONIC DEVICES

(75) Inventor: JOHN VAN DEN NIEUWENHUIZEN, Chicago, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 11/423,994

(22) Filed: Jun. 14, 2006

(51) Int. Cl. H04M 1/00

(52) U.S. Cl. 455/575.1

(57) ABSTRACT

Disclosed are rotator style form factor electronic devices. In one embodiment, the rotator style form factor of an electronic device (102) includes a first housing module (104) which may be a keypad (110) and microphone (115) module with a first surface or face (316) having a non-zero first curvature (314) and a second housing module (106) which may be a display (112) and speaker (117) module with a second surface or face (318) having a non-zero second curvature (314) so that the second surface corresponds to the first surface. The first and second curvatures (316, 314) can be substantially the same. The rotator style electronic devices further include a rotator hinge (108) to couple the first housing module (104) to the second housing module (106).

### FIELDC

Described is a rotator style form factor for electronic devices having two housing modules that can be twisted relative to one another.

### BACKGROUND

Mobile communication devices are increasingly popular for communication and other tasks. Mobile communication devices are offered in many different form factors. Different housing shapes and configurations can provide certain individual features. The “rotator style” form factor is popular as well as the “candy bar” form factor and the “clam shell” form factor. Each form factor has its benefits. The clam shell form factor can provide a good fit-to-face perception for the consumer. Efforts have been made to improve the rotator style mobile communication device so that its fit-to-face is similar to that of the clam shell form factor.

In a rotator style form factor, a “dog-leg tilt” configuration can provide a good fit-to-face. Typically in the dog-leg tilt form factor, the rotating module has an obvious angle while the stationary module is substantially flat. Mobile communication devices having a dog-leg tilt may not provide tight tolerances because there can be a large gap between the rotating and stationary modules, both in an open position and in a closed position. In design engineering, tight tolerances are preferred for device longevity, smoothness of operation and maneuverability.

In a rotator style form factor, it would be beneficial if the shapes and joining configuration of a rotating module and a stationary module were to provide a good fit-to-face. It would be advantageous if the rotator style form factor mobile communication device provided both a good fit-to-face and tight tolerances between the rotating and stationary modules.

### BRIEF DESCRIPTION OF THE DRAWINGS

FIG. 1 depicts a front view of a rotator style form factor electronic device in accordance with an embodiment;

FIG. 2 is a side view that illustrates the electronic device of FIG. 1 in a closed position in accordance with an embodiment;

FIG. 3 is a side view that illustrates the electronic device of FIG. 1 in an open position in accordance with an embodiment;

FIG. 4 shows a top down view of the electronic device of FIG. 1 in accordance with an embodiment;

FIG. 5 shows a side view detailing two housing modules coupled by a rotator hinge in accordance with an embodiment; and

FIG. 6 shows an enlargement of the rotator cup section of FIG. 5.

### DETAILED DESCRIPTION

Disclosed are rotator style electronic device form factors. In one embodiment, the rotator style form factor of the electronic devices includes a first housing module with a first surface or face having a non-zero first curvature and a second housing module with a second surface or face having a non-zero second curvature so that the second surface corresponds to the first surface. The first and second curvatures have substantially the same curvature. The rotator style electronic device further includes a rotator hinge to couple the first housing module to the second housing module.

In another embodiment, the rotator style form factor of the electronic device includes a first housing module having a first face with a curvature, and a second housing module having a second face with a curvature complementary to the first face with a curvature. In an opened position of the two housing modules, the two housing modules are geometrically skewed to one another. The term “skew” can have different meanings in different contexts. As described below, the term is used in its geometrical context.

In another embodiment, the rotator style form factor of the electronic device includes two housing modules coupled by a rotator hinge. The first housing module has an interior and includes an axisymmetric surface convex in a direction toward the interior of the first housing. The second housing module has an interior and includes an axisymmetric surface concave in a direction toward the interior of the second housing module.

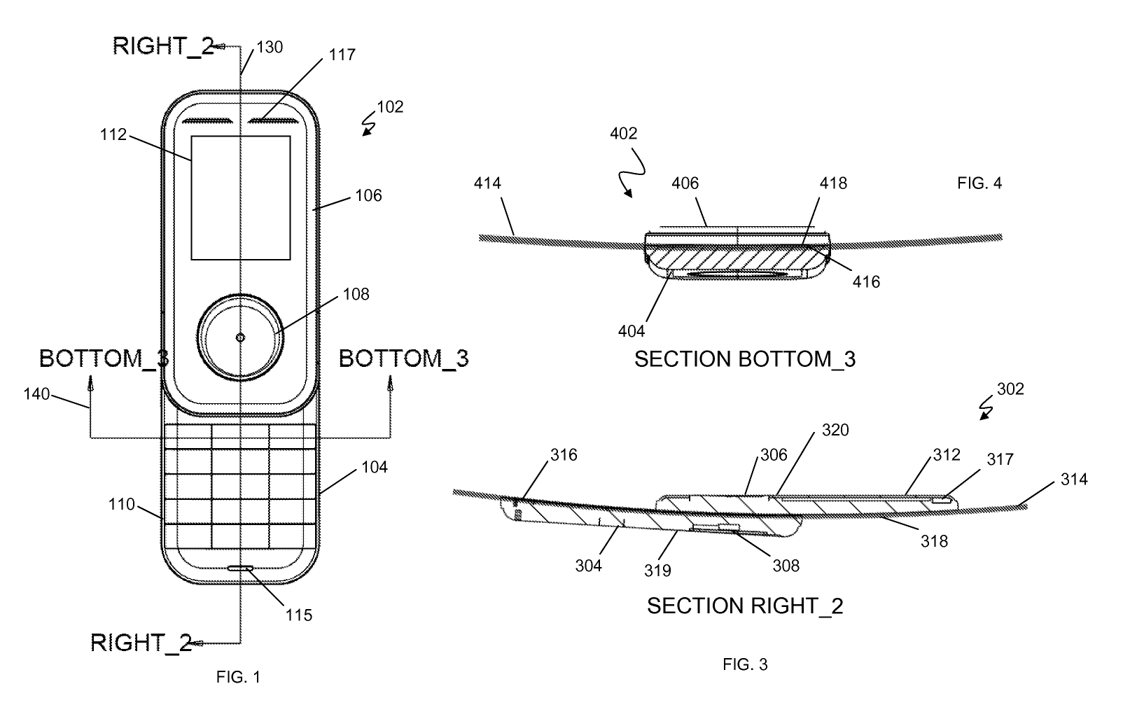

FIG. 1 depicts a front view of a rotator style form factor electronic device in accordance with an embodiment. The electronic device 102 may be implemented as a mobile or wireless communication device such as a cellular telephone (also called a mobile phone). The electronic device 102 represents a wide variety of devices. Such handheld electronic devices include, for example, messaging devices, personal digital assistants (PDAs), notebook or laptop computers incorporating communication modems, cordless telephones, mobile data terminals, application specific gaming devices, video gaming devices, and the like. Any of these portable devices may also be referred to as a mobile station or user equipment.

FIG. 1 depicts the electronic device 102 in an open position. The first housing module 104, which can be considered the stationary module, and the second housing module 106, which can be considered the rotating module, are coupled by a rotator hinge 108. Note that the stationary module 104 is deemed “stationary” only for convenience and in deference to general usage. It is possible to keep the module 106 stationary and rotate the module 104 instead; however, most users do not open rotator style form factor electronic devices in this fashion. It is also possible to move both modules to open and close the electronic device, but that is often difficult to handle.

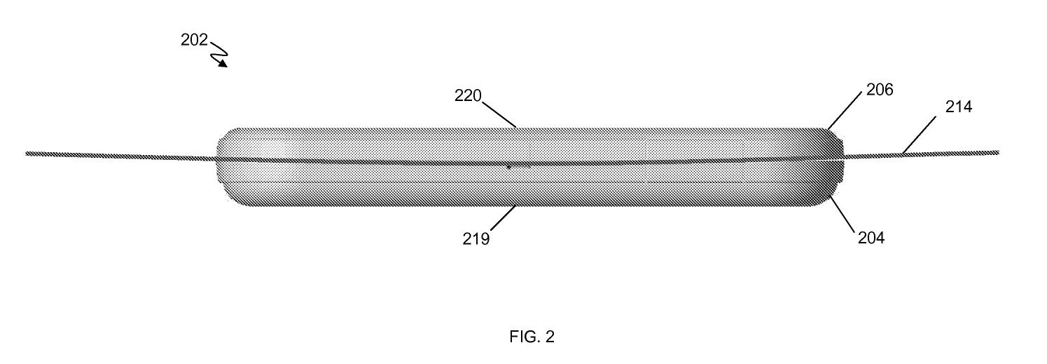

FIG. 2 is a side view 202 that illustrates the electronic device of FIG. 1 in a closed position in accordance with an embodiment. In a closed position, the stationary module 204 is positioned so that it is aligned with and generally covered by the rotating module 206. Stationary module 204 has a flat outer surface 219 as shown. Rotating module 206 has an opposing flat outer surface 220 as shown. In the closed position, the two housing modules are configured to be substantially parallel to one another. An interface between the two modules 204, 206 lies along an arc 214 whose curvature may be exaggerated for illustrative purposes. In the closed position the flat outer surfaces 219, 220 are substantially parallel, and one housing module overlaps the other.

Returning to FIG. 1, the rotating module 106, when in an open position, is rotated so that a keypad 110 and a microphone 115 of the stationary module 104 are exposed and available to the user. The microphone 115 and a loudspeaker 117 can be positioned at opposite ends of the device 102 in the open position so that when a user positions the device against his or her head, the microphone 115 is close to the user's mouth and the loudspeaker 117 is close to the user's ear. A display 112 and the loudspeaker 117 can be available while the electronic device 102 is in both the closed position and the open position as well as any intermediate position.

FIG. 3 is a side view 302 that illustrates the electronic device of FIG. 1 in an open position in accordance with an embodiment. While the curvature depicted by an arc 314 may be exaggerated for illustrative purposes, it is shown that between the stationary module 304 and the rotating module 306 there is an arc 314. The arc 314 represents the curvature of the first surface 316 of the stationary module 304 and the corresponding second surface 318 of the rotating module 306. The curvatures of the first surface 316 and the second surface 318 provide that, when the device is in an opened position, the flat outer surfaces 319, 320 of the two housing modules 304, 306 are geometrically skewed relative to one another. To provide a good fit-to-face, the angle formed from lines extending from the flat outer surfaces 319, 320 is approximately 150 degrees in this embodiment.

FIG. 3 further illustrates that the two housing modules are configured to be capable of being in an opened position so that the two housing modules 304 and 306 are each extended with respect to one another from the rotator hinge 308. Taken along the cross section 130 of FIG. 1, it is illustrated that the two housing modules can be in tight correspondence at the rotator hinge 308.

The first surface 316 and the second surface 318 can have spheroidal curvatures. A sphere is an example of a spheroid. The curvature of the surfaces 316 and 318 may be spherical. The spherical curvature may correspond to a radius of approximately between 550 and 750 millimeters. The keypad (110, see FIG. 1) may form part of the curvature of the first surface 316 of the stationary module 304 so that its face follows the curvature of the surface of the housing module. The second housing module 306 may also include a substantially flat surface 320, the flat surface 320 including a display screen 312 and a loudspeaker 317.

The configuration provided by the curvature of the first surface of the first housing module combined with the curvature of the second surface of the second housing module may provide a good fit-to-face, that is, similar to that of a clam shell form factor. For a good fit-to-face the loudspeaker 317 in the rotating module 306 and the microphone 115 (see FIG. 1) in the stationary module 304 may be positioned more closely to the user's ear and mouth, respectively, than without a curved configuration. In an embodiment, the surfaces have curvature in three dimensions, resembling a section of a sphere or of a spheroid.

FIG. 4 shows a top down view 402 of the electronic device of FIG. 1 in accordance with an embodiment. Taken along the cross section 140 of FIG. 1, the two housing modules are shown having surfaces 416 and 418 having the curvature of an arc 414. The curvature of the arc 314 (see FIG. 3) taken along the side view and the curvature of the arc 414 taken along the top view illustrate that a single surface having a compound curvature may be defined between the two housing modules. The curvature of the arc 314 of FIG. 3 and the curvature of the arc 414 can have the same radius and can also have the same center to form a sphere. If the curvatures of the arc 314, 414 differ, then they form a spheroid. The parting-surface between the rotating module 406 and the stationary module 404, that is, the surface that separates the two modules, may be a portion of a large sphere or spheroid. The correspondence or relationship between the rotating module 406 and the stationary module 404 can minimize the clearance of the gap between the two modules in the described non-planar rotator form factor electronic device.

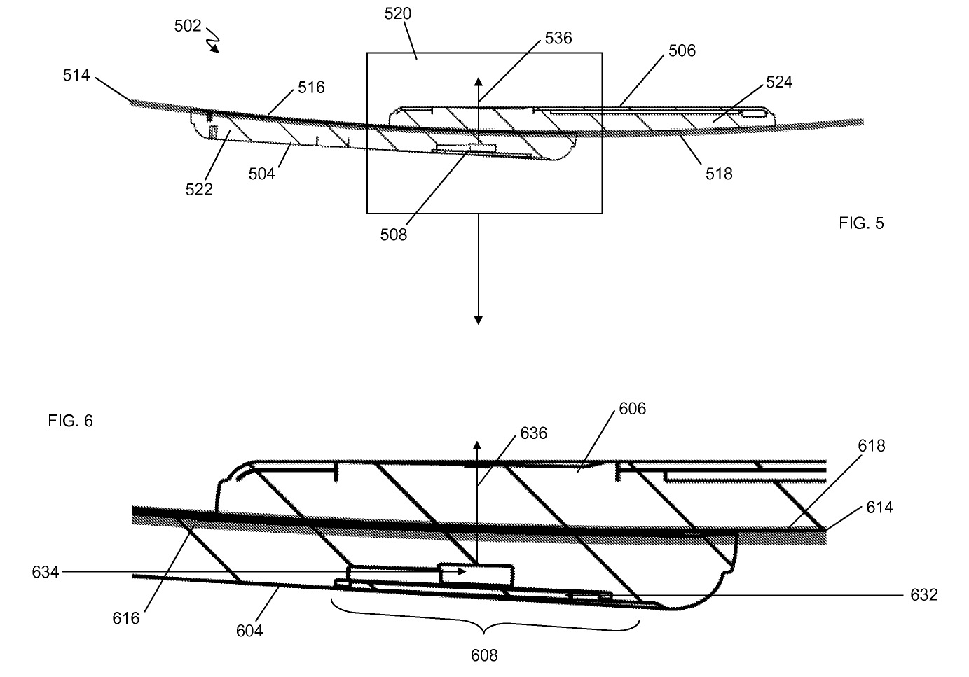

FIG. 5 shows a side view 502 detailing two housing modules coupled by a rotator hinge 508 in accordance with an embodiment. The first housing module 504 has an interior 522 and includes an axisymmetric surface 516 convex in a direction toward the interior 522 of the first housing 504. The second housing module 506 has an interior 524 and includes an axisymmetric surface 518 concave in a direction toward the interior 524 of the second housing module 506. The axisymmetric convex surface 516 of the first housing module 504 passes through an axis 536 of the rotator hinge 508. Also, the axisymmetric concave surface 518 of the second housing module 506 passes through the axis 536 of the rotator hinge 508. The terms concave and convex are used with respect to the interior of the respective housing modules 504 and 506. It is understood that the terminology of convex and concave are relative terms that may be defined with respect to any surface and/or direction. Both axisymmetric surfaces 516, 518 lie substantially along the curvature of an arc 514

FIG. 5 is similar to FIG. 3 but shows the device with a cut away 520 to illustrate certain components of the rotator hinge 508. FIG. 6 shows an enlargement of the rotator hinge section of FIG. 5. In FIG. 6, the rotator hinge 608 is shown to include a rotator hub 632 and a rotator cam 634. While the rotator hinge 608 is illustrated as a ball in cup configuration, it is understood that any suitable hinge for the rotator style form factor is within the scope of this discussion.

In FIG. 6 the curve 614 represents a curvature of the first surface 616 and the curvature of the second surface 618. As in previously described figures, each housing module has a surface with a non-zero curvature. In one embodiment, the rotator hinge has a rotation axis 636 normal to the first surface 616 of the first housing module 604. In another embodiment, the rotator hinge has a rotation axis 636 normal to the second surface 618 of the second housing module 606. While indicated as the same rotational axis 636 for both the first surface 616 and the second surface 618, the rotational axis 636 for each surface 616 and 618 may be slightly different due to tolerances of the fit between the two modules 604 and 606. It is understood that the type of rotator hinge and the curvature of the surface may dictate the actual rotational axis 636 for each surface 616 and 618. It is understood that any the terminology of “normal” is a relative term and may be defined with respect to any surface and/or direction.

Referring to both FIGS. 5 and 6, as mentioned above, the curve 514, 614 may be illustrated in an exaggerated manner so that the curvature is evident in the figures. However, the curvature may be more slight than shown. Alternatively, the curvature may be greater than shown. Possible dimensions of the curvature of the surfaces of the first housing module and the second housing module were mentioned previously. While those dimensions may be described here, it is understood that the first housing may have a surface with a curvature different from the curvature of the surface of the second housing. It is understood that good fit-to-face and tight tolerances may be provided in a rotator form factor telephone having dimensions different than those described herein. Providing a curvature to the corresponding surfaces of the first and second housing modules of a device having a rotator style form factor can provide a joining configuration having a good fit-to-face while having substantially tight tolerances therebetween.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, rotating and stationary, and the like are used solely to distinguish one from another entity or action without necessarily requiring or implying any actual such relationship or order between such entities or actions.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A rotator style form factor electronic device, comprising:
a first housing module with a first surface having a non-zero first curvature;
a second housing module with a second surface having a non-zero second curvature, the second surface corresponding to the first surface; and
a rotator hinge coupling the first housing module to the second housing module;
wherein the first curvature and the second curvature are substantially similar.

2. The device of claim 1 wherein the first curvature is a spheroidal curvature.

3. The device of claim 1 wherein the first curvature comprises a radius approximately between 550 and 750 millimeters.

4. The device of claim 1 wherein the rotator hinge has a rotation axis normal to the first surface.

5. The device of claim 1 wherein the rotator hinge has a rotation axis normal to the second surface.

6. The device of claim 1 wherein the rotator hinge comprises a ball-in-cup configuration.

7. The device of claim 1, wherein:
the first housing module further comprises a first substantially flat surface;
the second housing module further comprises a second substantially flat surface; and
two housing modules are configured to be capable of being in a closed position so that the first substantially flat surface and the second substantially flat surface are substantially parallel to one another.

8. The device of claim 1, wherein:
the first housing module and the second housing module are configured to be capable of being in an opened position wherein the first housing module and the second housing module comprise a non-planar angle of approximately 150 degrees.

9. The device of claim 1 wherein the first housing module comprises a loudspeaker.

10. The device of claim 1 wherein the second housing module comprises a microphone.

11. The device of claim 1 wherein the first housing module comprises a keypad.

12. The device of claim 11. wherein the keypad forms part of the first curvature.

13. The device of claim 1 wherein the second housing module further comprises a substantially flat outer surface, the substantially flat outer surface including a display screen.

14. A rotator style form factor electronic device comprising:
a first housing module having a first surface with a curvature;
a second housing module having a second surface complementary to the curvature; and
a rotator hinge coupling the first housing module to the second housing module;
wherein in an opened position, the first housing module is skewed relative to the second housing module.

15. The device of claim 14, wherein:
the first housing module further comprises a first substantially flat surface;
the second housing module further comprises a second substantially flat surface; and
two housing modules are configured to be capable of being in a closed position so that the first substantially flat surface and the second substantially flat surface are substantially parallel to one another.

16. The device of claim 15 wherein the first housing module and the second housing module in the opened position are extended with respect to one another from the rotator hinge, with the first substantially flat surface and the second substantially flat surface creating a non-planar angle of approximately 150 degrees

17. A rotator style form factor electronic device, comprising:
a first housing module and a second housing module coupled by a rotator hinge;
wherein the first housing module has a first interior and has a first axisymmetric convex surface directed toward the first interior;
wherein the second housing module has a second interior and has a second axisymmetric concave surface directed toward the second interior;
wherein a first axis of the first axisymmetric convex surface passes through the rotator hinge; and
wherein a second axis of the second axisymmetric concave surface passes through the rotator hinge.

18. The device of claim 17 wherein the first axisymmetric convex surface has a curvature that is a spheroid curvature with a radius approximately between 550 and 750 millimeters.

19. The device of claim 17 wherein the second axisymmetric concave surface has a curvature that is a spheroid curvature with a radius approximately between 550 and 750 millimeters.
